(19) United States
(12) Patent Application Publication
(10) Pub. No.: US 2012/0067696 A1
(43) Pub. Date: Mar. 22, 2012

(54) METHOD AND APPARATUS FOR DIVERTING SHINGLES

(75) Inventor: David P. Aschenbeck, Newark, OH (US)

(73) Assignee: OWENS CORNING INTELLECTUAL CAPITAL, LLC, Toledo, OH (US)

(21) Appl. No.: 13/233,142

(22) Filed: Sep. 15, 2011

Related U.S. Application Data
(60) Provisional application No. 61/383,502, filed on Sep. 16, 2010.

(51) Int. Cl. B65G 47/46

(52) U.S. Cl. 198/370.08; 198/370.01

(57) ABSTRACT

A method of diverting shingles including moving a plurality of shingles along a first path on a moving belt, and urging every other one of the plurality of moving shingles into a second path.

### CROSS REFERENCE TO RELATED APPLICATIONS

This application claims the benefit of U.S. Provisional Application No. 61/383,502 filed Sep. 16, 2010.

### BACKGROUND

This invention relates in general to a method of manufacturing roofing shingles, and in particular to an improved method of diverting shingles during a shingle manufacturing process.

Laminated shingle manufacturing processes often require that every other shingle be diverted because a subsequent catching and stacking operation may not be accomplished with a single stream of shingles at known high manufacturing line speeds. With a diverter, shingles are diverted into two paths, each having a catch and stack assembly.

One known diverter is schematically illustrated at 64 in FIG. 3. The illustrated wedge 64 is shown downstream of a known shingle manufacturing apparatus, a portion of which is shown at 70. The shingle manufacturing apparatus is an assembly structured and configured to move a stream of shingles. The shingle manufacturing apparatus 70 includes a wedge shaped member or wedge 64. The wedge 64 provides stationary surfaces upon which the shingles impact and slide. The wedge 64 may pivot about a pivot axis 66 between a first position, as shown at 64, and a second position, shown by the phantom line 64′, to direct every other shingle along one of two paths illustrated by the arrows 68A and 68B. As shown, shingles 48 move from the shingle manufacturing apparatus 70 to the wedge 64. The wedge 64 pivots between the first position 64 and the second position 64′. When the wedge 64 is in the first position 64, a shingle 48 is directed along the first path 68A to a first belt assembly 72. When the wedge 64 is in the second position 64′, a shingle 48 is directed along the second path 68B to a second belt assembly 74. Such a wedge 64 may include an actuator that rotates the diverter within the range of from about 10 degrees to about 30 degrees between shingles 48.

The impact and sliding of the shingle 48 on a surface of the wedge 64 creates friction that may slow the shingle 48, and further cause the tail of the shingle 48 to flip onto the upstream end of the diverter 64. Such a flip action may result in undesirable drag on the shingle 48. The amount of drag may vary from shingle to shingle. The changes in drag further cause undesirable variation in the gap between shingles 48, which may further cause the shingle manufacturing apparatus to jam at the diverter or the catcher.

Copending U.S. patent application Ser. No. 12/428,079 to David P. Aschenbeck discloses a method and apparatus for twisting and stacking shingles 48 in which shingles are separated into two paths. Shingles in one of the two paths are inverted in a twister belt assembly. U.S. patent application Ser. No. 12/428,079 is commonly assigned, has the same inventor as the present application, and is incorporated herein by reference.

The above notwithstanding, there remains a need in the art for an improved method of diverting shingles prior to stacking and packaging.

### SUMMARY

The present application describes various embodiments of a method and apparatus for diverting shingles. One embodiment of the method of diverting shingles includes moving a plurality of shingles along a first path on a moving belt, and urging every other one of the plurality of moving shingles into a second path.

The present application also describes various embodiments of a shingle manufacturing apparatus including a first assembly structured and configured to move a stream of shingles. A diverter assembly is structured and configured to engage and separate every other shingle in the stream of shingles into a first stream on a first conveyor and a second stream on a second conveyor. The diverter assembly includes a hold-down member structured and configured to engage the shingles moving in the first stream of shingles as the shingles move along a first path on a moving belt toward the first conveyor. A rotatable member is structured and configured to engage every other of the shingles moving in the first stream of shingles and urge each of the every other shingles into a second path toward the second conveyor.

In another embodiment, the shingle manufacturing apparatus includes a first assembly structured and configured to move a stream of shingles. A diverter assembly is structured and configured to engage and separate every other shingle in the stream of shingles into a first stream on a first conveyor and a second stream on a second conveyor. The diverter assembly includes a rotatable shaft. A support arm is mounted to the rotatable shaft. An idler wheel is rotatably mounted to the support arm and is structured and configured to engage the shingles moving in the first stream of shingles as the shingles move along a first path on a moving belt toward the first conveyor. A diverter wheel is rotatably mounted to the support arm and is structured and configured to engage every other of the shingles moving in the first stream of shingles and urge each of the every other shingles into a second path toward the second conveyor.

Other advantages of the method of diverting shingles and the shingle manufacturing apparatus will become apparent to those skilled in the art from the following detailed description, when read in view of the accompanying drawings.

### BRIEF DESCRIPTION OF THE DRAWINGS

FIG. 1 is a schematic illustration of a known process for making shingles.

FIG. 2A is an exploded schematic perspective view of a known laminated shingle.

FIG. 2B is a schematic plan view of the laminated shingle illustrated in FIG. 2A.

FIG. 3 is a schematic elevational view of a known diverter.

FIG. 4 is a schematic elevational view of a first embodiment of a diverter assembly according to the invention, showing the second wheel assembly in the engaged position.

FIG. 5 is a schematic elevational view of the diverter assembly illustrated in FIG. 4, showing the second wheel assembly in the disengaged position.

FIG. 6 is a schematic top plan view of the diverter assembly illustrated in FIGS. 4 and 5.

FIG. 7 is a schematic elevational view of a wheel of the second wheel assembly illustrated in FIGS. 4 and 5.

FIG. 8 is a schematic elevational view of a second embodiment of a diverter assembly.

FIG. 9 is a schematic perspective view of a portion of a third embodiment of a diverter assembly.

FIG. 10 is a schematic perspective view of a portion of a fourth embodiment of a diverter assembly.

FIG. 11 is a schematic perspective view of a portion of a fifth embodiment of a diverter assembly.

FIG. 12 is a schematic perspective view of a portion of a sixth embodiment of a diverter assembly.

FIG. 13 is a schematic elevational view of a seventh embodiment of a diverter assembly.

FIG. 14 is a perspective view of the diverter assembly illustrated in FIG. 13.

### DETAILED DESCRIPTION

The present invention will now be described with occasional reference to the illustrated embodiments of the invention. This invention may however, be embodied in different forms and should not be construed as limited to the embodiments set forth herein, nor in any order of preference. Rather, these embodiments are provided so that this disclosure will be more thorough, and will convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

Referring now to the drawings, there is shown in FIG. 1 a schematic illustration of a known manufacturing process 10 for manufacturing an asphalt-based roofing material.

In a first step 12 of the manufacturing process, a continuous sheet of substrate or shingle mat is typically payed out from a roll. The substrate may be any type known for use in reinforcing asphalt-based roofing materials, such as a nonwoven web of glass fibers. In a second step 14, a coating of asphalt is then applied to the sheet. The asphalt coating may be applied in any suitable manner sufficient to completely cover the sheet with a tacky coating of hot, melted asphalt. In a third step 16, granules are applied to the upper surface of the asphalt-coated sheet, thereby defining a granule covered sheet. Typically the granule covered sheet travels at a line speed greater than about 400 feet per minute, and may travel at a faster line speed, such as a line speed within the range of from about 600 feet per minute to about 800 feet per minute. Faster line speeds are possible.

In a fourth step 18, the granule covered sheet may be cut into continuous underlay sheets and continuous overlay sheets. In a fifth step 20, each continuous underlay sheet is directed to be aligned beneath a continuous overlay sheet, and the two sheets are laminated together to form a continuous laminated sheet. In a sixth step 22, the continuous underlay sheet is passed into contact with a cutter, including but not limited to a rotary shingle cutter that cuts the laminated sheet into a running series of individual laminated shingles 48 ready for stacking and packaging. U.S. Pat. No. 6,748,714 to Bert W. Elliot discloses one known method for manufacturing laminated shingles and is incorporated herein by reference.

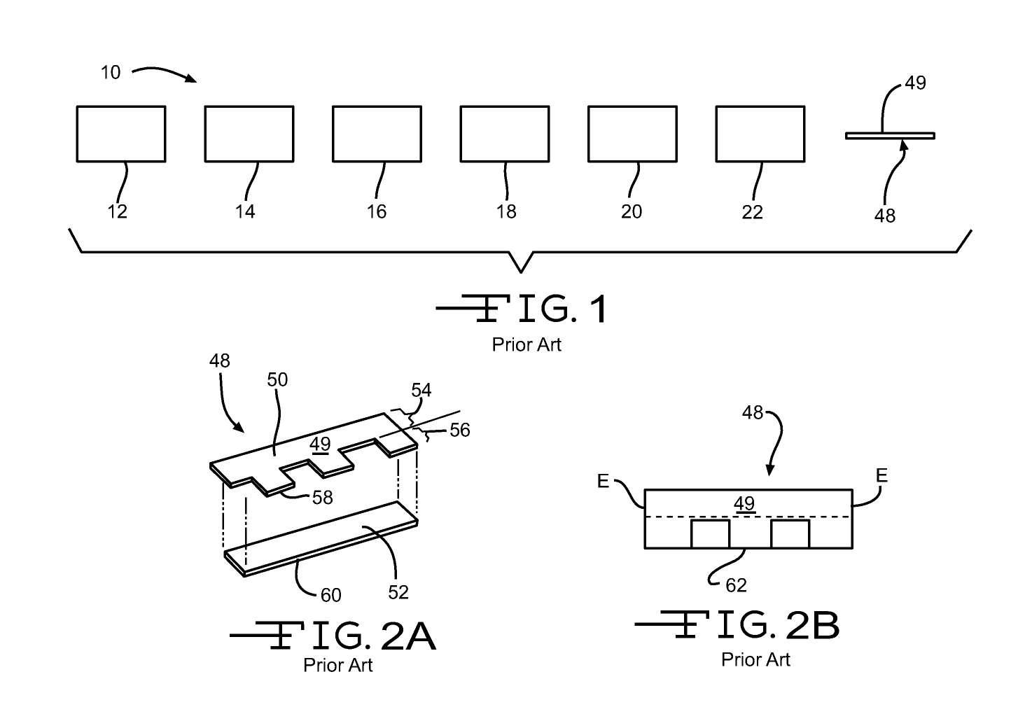

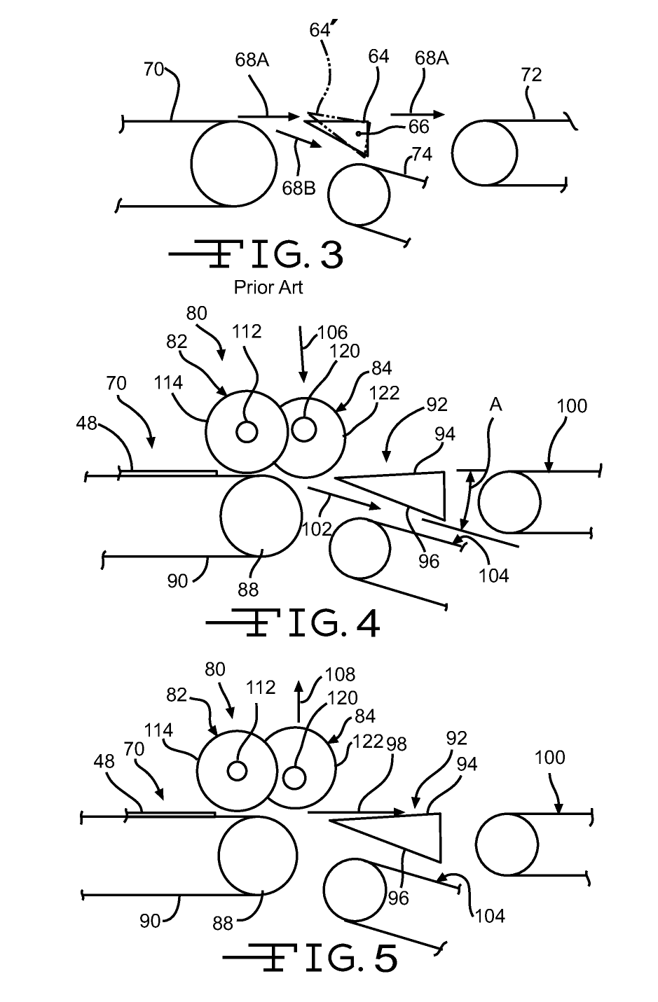

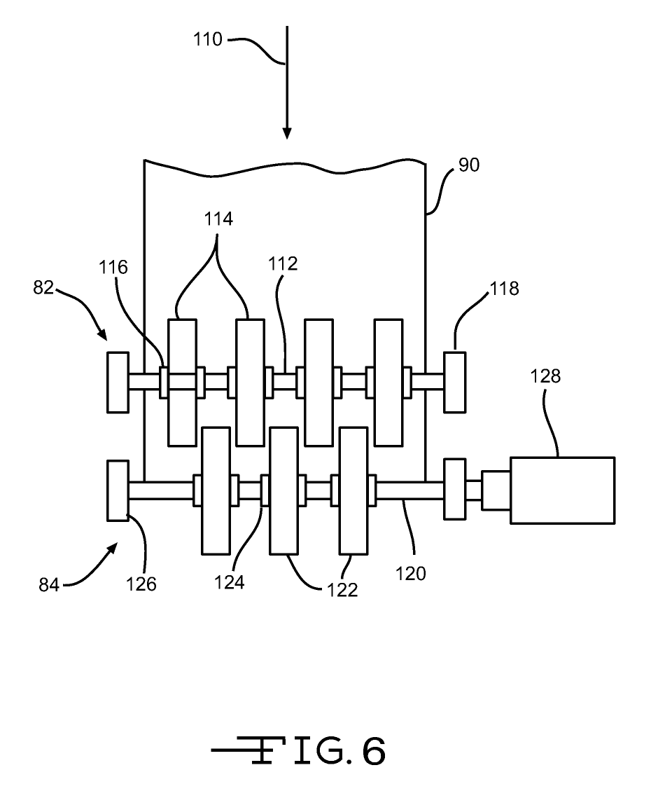

As shown in FIGS. 2A and 2B, the shingle 48 formed by the process illustrated in FIG. 1 includes an overlay sheet 50 and an underlay sheet 52, and defines a granule covered surface 49. The overlay sheet 50 includes an upper or headlap portion 54, a lower or butt portion 56, and end cuts or end surfaces E. A rear surface of the overlay sheet 50 (the downwardly facing surface when installed on a roof) and a front surface of the underlay sheet 52 (the upwardly facing surface when installed on a roof) are fixedly attached to each other to form the laminated shingle 48. Such attachment may be accomplished by using adhesive materials applied to the rear surface of the overlay sheet 50 and the front surface of the underlay sheet 52. In the illustrated embodiment, a butt edge 58 of the butt portion 56 of the overlay sheet 50 and a lower edge 60 of the underlay sheet 52 are vertically aligned to define a lower edge 62 of the shingle 48. If desired, a bead of adhesive (not shown) may be applied to a bottom surface of the underlay sheet 52. Although FIGS. 2A and 2B illustrate a laminated shingle, it will be understood that the method and apparatus of the invention may be used with single layer shingles, such as three-tab shingles.

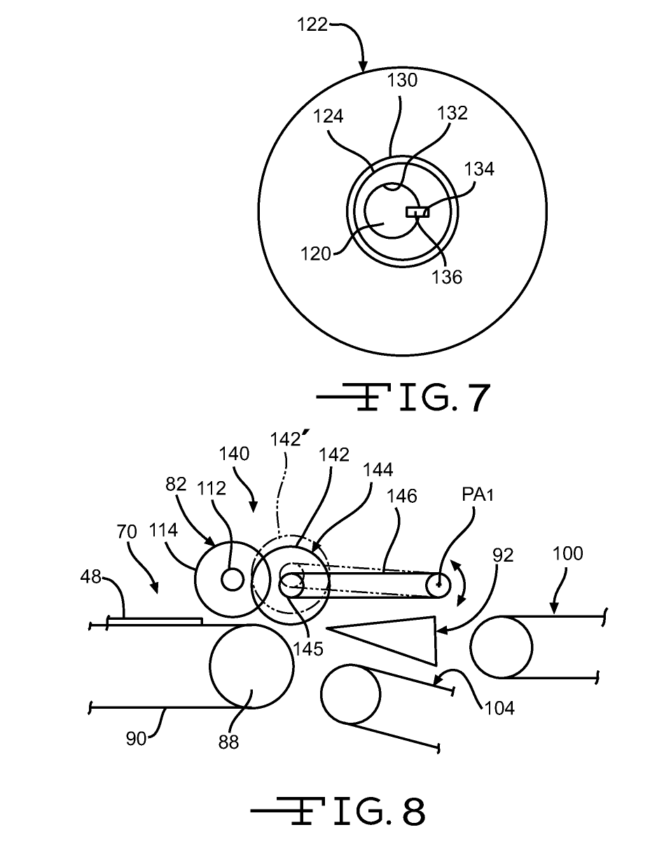

Referring again to the drawings, there is shown in FIGS. 4 through 7 a first embodiment of a diverter assembly 80 for diverting shingles 48, according to the invention. The diverter assembly 80 includes a hold-down assembly, shown here as a first wheel assembly 82 and a second wheel assembly 84, both described in detail below. The first and second wheel assemblies 82 and 84 are mounted above the downstream end of a shingle manufacturing apparatus, such as the shingle manufacturing apparatus 70. In the embodiment schematically illustrated in FIGS. 4 and 5, only the tail roll 88 and speed-up belt 90 of the shingle manufacturing apparatus 70 are shown. A diverter member, illustrated as a wedge 92, is mounted downstream of the second wheel assembly 84. The illustrated wedge 92 has a substantially triangular cross-sectional shape and has a first side or surface 94 (upper surface when viewing FIGS. 4 and 5) and a second side or surface 96 (lower surface when viewing FIGS. 4 and 5). The wedge 92 may be formed from any suitable material. Examples of suitable materials include steel, aluminum, and engineered plastics. The face surfaces 94 and 96 that contact the shingle may be covered by any wear resistant material suitable for use in a roofing material manufacturing plant, such as steel with a high-wear resistant surface. Any other suitable metal and non-metal may also be used. One example of such a suitable material is ceramic tile. The selection of material, structure, and dimensions of the wedge 92 may be determined by the dimensions of the shingle used in the particular application. It will be understood that the surfaces 94 and 96 of the wedge 92 may have any other desired shape or contour, such as a concave or a convex shape.

A first belt assembly 100 and a second belt assembly 104 are also mounted downstream of the second wheel assembly 84 and wedge 92 to carry the laminated shingles 48 to a subsequent, downstream manufacturing apparatus, such as an apparatus for catching, stacking, and/or packaging (not shown).

As best shown in FIG. 6, the illustrated hold-down assembly comprises the first wheel assembly 82, which includes a plurality of idler wheels 114 mounted to a shaft 112. Distal ends of the illustrated shaft 112 are rotatably mounted in bearings 118. In the illustrated embodiment, the wheels 114 are mounted to the shaft 112 through bushings 116.

Referring again to FIG. 6, the second wheel assembly 84 includes a plurality of wheels 122 mounted to a shaft 120. Ends of the illustrated shaft 120 are rotatably mounted in bearings 126. In the illustrated embodiment, one distal end of the shaft 120 is operably attached to a motor 128 which rotates the shaft 120. The wheels 122 are rotatably mounted to the shaft 120 through bushings 124. Alternatively, the shaft 120 may be rotated by an actuator or by other desired means, such as a motor/clutch/brake positioning system. In an embodiment according to the present invention, the motor 128 comprises a servo motor.

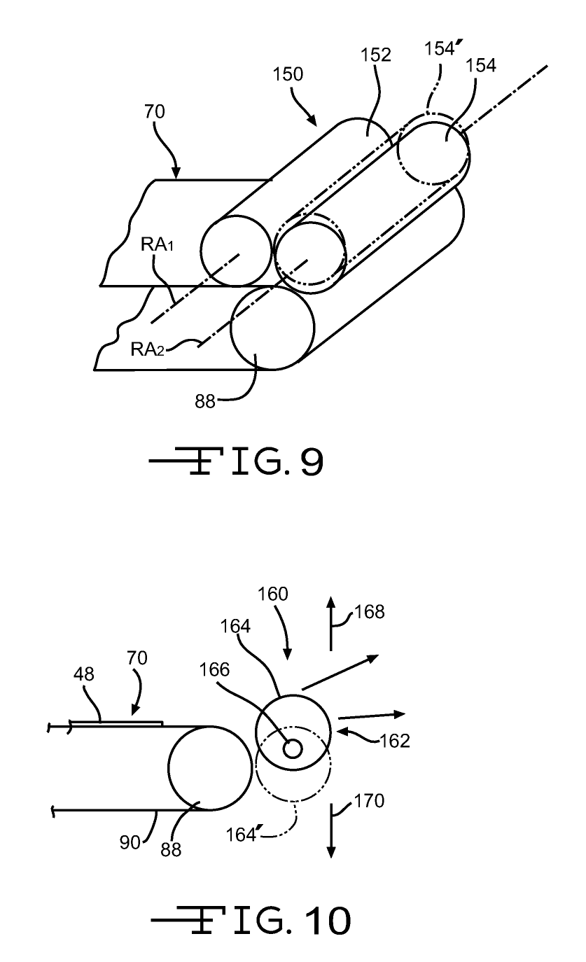

Referring now to FIG. 7, a schematic side elevational view of a wheel 122 is illustrated. In the illustrated embodiment, the shaft 120 is mounted off-center of the wheel bushing 124. The shaft 120 and the wheel bushing 124 may be attached together by a key 136 mounted within a keyway 134 formed in the shaft 120 and the wheel bushing 124. The illustrated wheel bushing 124 is concentrically mounted within a bearing 130, such as a wheel bearing. The illustrated bearing 130 is concentrically mounted within the wheel 122. The bearing 130 allows the wheel 122 to rotate freely about the bearing 124.

In the illustrated embodiment, the off-center mounting of the shaft 120 relative to the wheels 122 causes the rotating second wheel assembly 84 to function as an eccentric. For example, the shaft 120 may be mounted off-center of the wheel 122 a distance within the range of from about ⅛ inches to about ½ inches. It will be understood that the shaft 120 may also be mounted off-center a distance of less than about ⅛ inch or greater than about ½ inch. In the illustrated embodiment, the shaft 120 is mounted off-center about 3/16 inch. Thus, as the shaft 120 rotates, the wheels 122 have a linear (vertical when viewing FIGS. 4 and 5) travel stroke of about ⅜ inch. The wheels 114 and 122 may have a diameter within the range of from about 4.0 inches to about 8.0 inches. In the illustrated embodiment, the wheels 114 and 122 have a diameter of about 6.0 inches. Alternatively, the wheels 114 and 122 may have any other desired diameter.

It will be understood that the shaft 120 may rotate between about 0 degrees and about 180 degrees, thereby moving the second wheel assembly 84 between the engaged and the disengaged positions. Alternatively, the shaft 120 may rotate 360 degrees, thereby also moving the second wheel assembly 84 between the engaged and the disengaged positions.

In the illustrated embodiment, four wheels 114 and three wheels 122 are shown. It will be understood however, that any desired number of wheels 114 and wheels 122 may be provided on the shafts 112 and 120, respectively.

As shown in FIG. 6, portions of the wheels 122 of the second wheel assembly 84 extend into the spaces between the wheels 114 of the first wheel assembly 82. Similarly, portions of the wheels 114 of the first wheel assembly 82 extend into the spaces between the wheels 122 and into the space adjacent the outboard wheels 122 of the second wheel assembly 84, such that the wheels 114 and 122 are intermeshed. In the illustrated embodiments, the outer circumferential surfaces of the wheels 114 and 122 are formed of a suitable high-wear material such as rubber or urethane. Alternatively, the outer circumferential surfaces of the wheels 114 and 122 may be formed of any desired material, such as chromed or hardened steel.

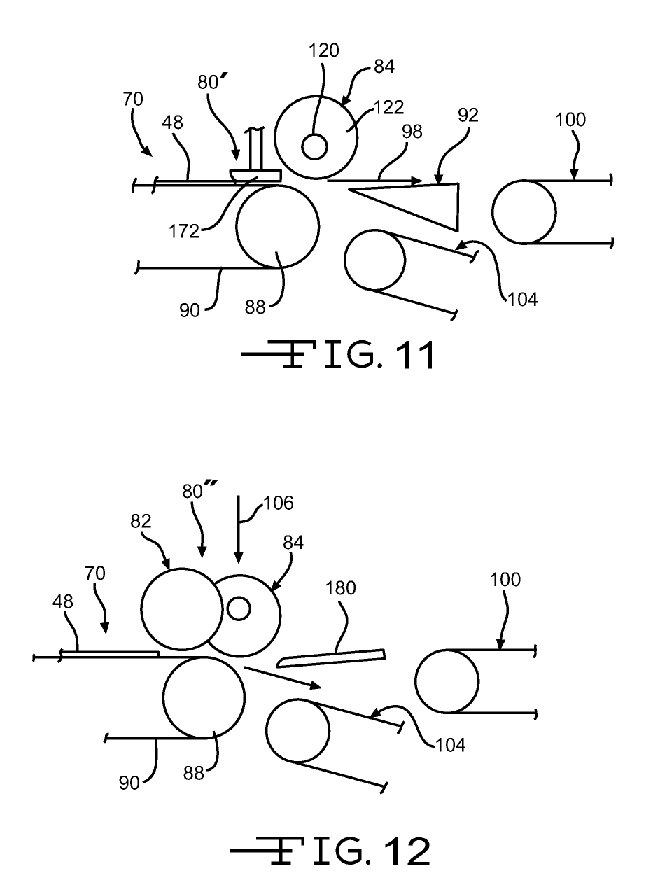

Alternatively, the wheels 114 and 122 need not be intermeshed and may be formed as cylindrically shaped rollers, such as shown at 152 and 154 in FIG. 9. Such rollers 152 and 154 may be driven by a motor (not shown in FIG. 9), an actuator, belts, or by other desired means, such as a motor/clutch/brake positioning system.

In the illustrated embodiments, the second wheel assembly 84 is movable between two extremes of travel defining a first or engaged position and a second or disengaged position. In the first position, the wheels 114 of the second wheel assembly 84 are at the first extreme of travel (downward when viewing FIG. 4) in the direction of the arrow 106. In the second position, the wheels 114 of the second wheel assembly 84 are at the second extreme of travel (upward when viewing FIG. 5) in the direction of the arrow 108.

In operation, a shingle 48 is carried by the belt 90 toward the diverter assembly 80. The wheels 114 engage and rotate with, the moving shingles 48 substantially at the speed of the belt 90. There is substantially no wheel speed difference between the surface of the wheels 114 and the shingles 48. Therefore, there is substantially no drag force on the shingle 48. In the illustrated embodiment, the wheels 114 ensure that the shingles 48 remain in contact with the moving belt 90, and ensure that the tails of the shingles 48 do not flip as the shingles 48 move through the diverter assembly 80, particularly along the second path 102, described below. For example, when a shingle 48 is bent over the tail roll 88 by the wheels 122 of the second wheel assembly 84, and as the tail of the shingle 48 approaches the wheel 122, the tail has a low cantilevered weight. Thus, the bending force is greater than the tail weight of the shingle 48, and the tail wants to lift. The wheels 114 prevent the tail of the shingle 48 from lifting or flipping upwardly. In the illustrated embodiment, the wheels 114 are spaced above the belt 90 at a distance approximately equal to the thickness of the shingle, or slightly greater, to prevent the tail of the shingle 48 from lifting or flipping upwardly when diverted by the second wheel assembly 84.

Although not shown in FIG. 5, the shaft 112 of the first wheel assembly 82 may be operably attached to a motor, such as the motor 128, which rotates the shaft 112. Additionally, the shaft 112 may be rotated by an actuator or by other desired means, such as a motor/clutch/brake positioning system. In one embodiment, the first wheel assembly 82 rotates at a tangential speed substantially equal to the speed of the belt 90.

The shaft 120 of the second wheel assembly 84 is caused to rotate by the motor 128. The wheels 122 of the second wheel assembly 84 function as an eccentric and rotate between the first or engaged position and the second or disengaged position. When the wheels 122 are in the disengaged position as shown in FIG. 5, a shingle 48 is directed downstream along a first path, indicated by the arrow 98, toward the first belt assembly 100. As the shingle 48 travels along the first path 98, the shingle 48 may contact the first surface 94 of the wedge 92 before the shingle 48 is deposited on the first belt assembly 100. As a first one of the shingles 48 moves along the first path 98, a second, subsequent shingle 48 travels between the belt 90 and the wheels 114, and the shaft 120 rotates 180 degrees to the engaged position, as shown in FIG. 4.

When the wheels 122 are in the engaged position, a second shingle 48 is directed downstream along a second path, indicated by the arrow 102, toward the second belt assembly 104. In one embodiment, when moving on the second path 102, the shingles 48 do not normally come into contact with the second surface 96. Advantageously, there is substantially no speed difference between the surface of the wheels 122 and the shingles 48. Therefore, there is no drag force on the shingle 48.

Referring again to FIG. 4, the second path 102 is between the second surface 96 of the wedge 92 and the second belt assembly 104. In the illustrated embodiment, the shingle 48 is directed downstream along the second path 102 at an angle A below the original path of the shingle 48. In the illustrated embodiment, the angle A is about 15 degrees. Alternatively, the angle A may be within the range of from about 10 degrees to about 30 degrees. Additionally, the angle A may be any other desired angle, such as less than about 10 degrees or more than about 30 degrees. Thus, as described above, successive shingles 48 moving from the shingle manufacturing apparatus 70 to the diverter assembly 80 are moved in an alternating manner such that every other one of the shingles 48 alternates between the first path 98 and the second path 102.

Advantageously, the moving outer circumferential surfaces of the wheels 114 and 122 are quickly moved linearly between the engaged and disengaged positions (vertically when viewing FIGS. 4 and 5), or about ⅜ inch to either divert the shingle 48 along the second path 102, or allow the shingle 48 to pass onto the first path 98.

Referring now to FIG. 8, a second embodiment of the diverter assembly is illustrated generally at 140. The diverter assembly 140 is substantially similar to the diverter assembly 80 and like reference numbers are used to indicate corresponding parts.

In the illustrated embodiment, the wheels 142 of the second wheel assembly 144 are not eccentrically mounted to the shaft 145, rather the wheels 142 are concentrically mounted about the shaft 145, and the shaft 145 is further mounted to an arm 146. The arm 146 is pivotally mounted to a portion (not shown) of the diverter assembly 140 about a pivot axis PA₁.

The pivot arm 146 may be driven by any desired means, such as the motor 128. Alternatively, the pivot arm 146 may be pivoted by an actuator or by any other desired means, such as a linear actuator with a crank arm. In the illustrated embodiment, the pivot arm 146 is caused to pivot about the pivot axis PA₁ such that the pivot arm 146 moves within the range of from about 10 degrees to about 20 degrees.

In operation, the second wheel assembly 144 is movable between two extremes of travel defining a first or engaged position and a second or disengaged position. In the first position, the wheels 142 of the second wheel assembly 144 are at the first extreme of travel (downward when viewing FIG. 8). In the second position, the wheels 142 of the second wheel assembly 144 are at the second extreme of travel (upward when viewing FIG. 8), as shown by the phantom line 142′. Thus, like the second wheel assembly 84, the wheels 142 of the second wheel assembly 144 may have a linear (vertical when viewing FIG. 8) travel stroke of about ⅜ inch when measured at the shaft 145.

Referring now to FIG. 9, a third alternate embodiment of the diverter assembly is illustrated generally at 150. The diverter assembly 150 does not include the intermeshed wheels 114 and 122. Rather, the diverter assembly 150 includes cylindrically shaped rollers 152 and 154 positioned adjacent one another. The roller 152 is rotatably mounted about an axis RA₁ and the roller 154 is rotatably mounted about an axis RA₂.

In operation, the roller 154 is movable between two extremes of travel defining a first or engaged position and a second or disengaged position. In the first position, the roller 154 is at the first extreme of travel (downward when viewing FIG. 9). In the second position, the roller 154 is at the second extreme of travel (upward when viewing FIG. 9), as shown by the phantom line 154′. Thus, like the wheels 142 of the second wheel assembly 144, the roller 154 may have a linear (vertical when viewing FIG. 9) travel stroke of about ⅜ inch.

The roller 152 may be driven at machine speed by engaging the shingles 48 and/or the belt 90 of the shingle manufacturing apparatus 70. Alternatively the roller 152 may be driven by a motor (not shown in FIG. 9), an actuator, belts, or by other desired means, such as a motor/clutch/brake positioning system. The roller 154 may also be driven by a motor (not shown in FIG. 9), an actuator, belts, or by other desired means, such as a motor/clutch/brake positioning system.

Referring now to FIG. 10, a fourth alternate embodiment of the diverter assembly is illustrated generally at 160. The diverter assembly 160 includes one roller or wheel assembly 162 positioned downstream of the tail roll 88. The illustrated diverter assembly 160 does not include the hold-down assembly or first wheel assembly 82.

The wheel assembly 162 may be substantially identical to the second wheel assembly 84 shown in FIG. 6, and may include one or more wheels 164 mounted off-center of the shaft 166. The shaft 166 may be operably attached to a motor (not shown) which rotates the shaft 166. Alternatively, the shaft 166 may be rotated by an actuator or by other desired means, such as a motor/clutch/brake positioning system. Thus, as the shaft 166 rotates, the wheels 164 have a linear (vertical when viewing FIG. 10) travel stroke of about ⅜ inch.

In the illustrated embodiment, the wheel assembly 162 is movable between two extremes of travel defining a first or engaged position and a second or disengaged position. In the first position, the wheels 164 of the wheel assembly 162 are at the first extreme of travel (upward when viewing FIG. 10) in the direction of the arrow 168. In the second position, the wheels, shown by the phantom line 164′, of the wheel assembly 162 are at the second extreme of travel (downward when viewing FIG. 10) in the direction of the arrow 170.

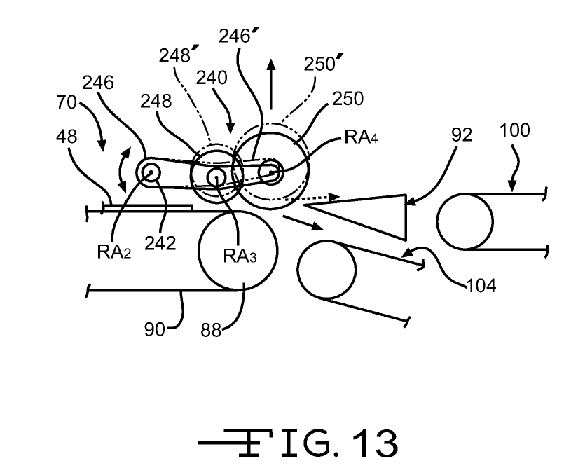

As shown in FIG. 11, a fifth embodiment of the diverter assembly 80′ may include a planar hold-down member 172 in lieu of the first wheel assembly 82. In the illustrated embodiment, the hold-down member 172 is a skid plate. Alternatively, the hold-down member 172 may be any other desired member or members, such as a plurality of skid plates or fingers.

As shown in FIG. 12, a sixth embodiment of the diverter assembly 80″ may include a diverter plate 180 in lieu of the wedge 92 shown in FIGS. 4, 5, 8, and 11.

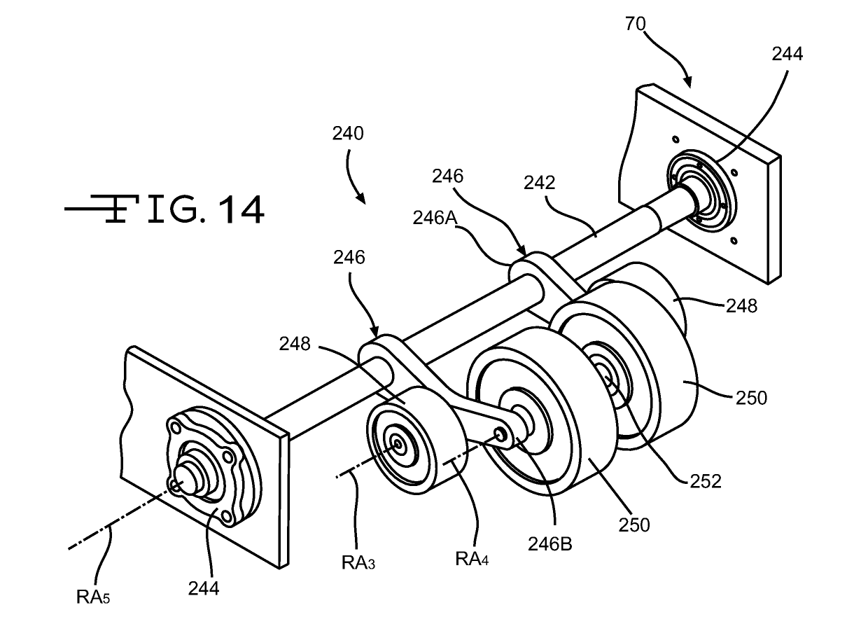

Referring now to FIGS. 12 and 13, a seventh embodiment of the diverter assembly is illustrated generally at 240. In the illustrated embodiment, the diverter assembly 240 includes a shaft 242 rotatably mounted between bearings 244 of the shingle manufacturing apparatus 70. A first end 246A of each of a pair of support arms 246 is attached to the shaft 242 such that the support arms 246 extend in a downstream direction.

Idler wheels 248 are substantially similar to the idler wheels 114. One idler wheel 248 is rotatably mounted to the outboard side of each of the arms 246 intermediate the first end 246A and a second end 246B about an axis RA₃. Two diverter wheels 250 are substantially similar to the wheels 142 and are rotatably mounted to a shaft 252 about an axis RA₄.

The idler wheels 248 may have a diameter within the range of from about 2.0 inches to about 6.0 inches. In the illustrated embodiment, the idler wheels 248 have a diameter of about 3.0 inches. Alternatively, the idler wheels 248 may have any other desired diameter. The diverter wheels 250 may have a diameter within the range of from about 4.0 inches to about 8.0 inches. In the illustrated embodiment, the diverter wheels 250 have a diameter of about 6.0 inches. Alternatively, the diverter wheels 250 may have any other desired diameter.

The shaft 242 may be driven by any desired means, such as the motor 128. Alternatively, the shaft 242 may be rotated by an actuator or by any other desired means, such as a linear actuator with a crank arm. In the illustrated embodiment, the shaft 242 and the attached arms 246 are caused to pivot about an axis PA₂.

In the illustrated embodiment, two idler wheels 248 and diverter wheels 250 are shown. It will be understood however, that any desired number of idler wheels 248 and diverter wheels 250 may be provided on the support arms 246.

In operation, the arms 246 pivot about the axis RA₂, causing the diverter assembly 240 to move between two extremes of travel defining a first or engaged position and a second or disengaged position. In the first position, the diverter wheels 250 are at the first extreme of travel (downward when viewing FIG. 13). In the second position, the diverter wheels 250 are at the second extreme of travel (upward when viewing FIG. 13), as shown by the phantom line 250′. Thus, like the wheels 142 of the second wheel assembly 144, the wheels 250 may have a linear (vertical when viewing FIG. 13) travel stroke of about ⅜ inch. It will be understood that the shaft 242 may rotate between about 0 degrees and about 180 degrees, thereby moving the diverter assembly 240 between the engaged and the disengaged positions.

It will be understood that if one of the catching and stacking apparatus downstream of either the first belt assembly 100 or the second belt assembly 104 becomes jammed or otherwise inoperative, the diverter assembly 80 and 140 may be shut off, so that all shingles 48 travel to the operative catching and stacking apparatus. In such an event, the line speed of the shingle manufacturing apparatus 70 will be reduced to about one-half or less of its top speed.

The principle and mode of operation of the method and apparatus for diverting shingles have been described in its preferred embodiment. However, it should be noted that the method and apparatus for diverting shingles described herein may be practiced otherwise than as specifically illustrated and described without departing from its scope.

What is claimed is:

1. A method of diverting shingles comprising:
moving a plurality of shingles along a first path on a moving belt; and
urging every other one of the plurality of moving shingles into a second path.

2. The method according to claim 1, further including engaging the plurality of moving shingles with a hold-down member during the step of urging every other one of the plurality of moving shingles into a second path.

3. The method according to claim 2, wherein the hold-down member comprises a first wheel assembly;
wherein the urging step is performed by a second wheel assembly; and
wherein the urging step further includes urging each of the every other shingles into the second path with the second wheel assembly.

4. The method according to claim 3, further moving the second wheel assembly between an engaged position and a disengaged position;
wherein in the engaged position, every other of the moving shingles is urged into the second path with the second wheel assembly.

5. The method according to claim 3, wherein the first wheel assembly includes a plurality of wheels rotatably mounted about an axis.

6. The method according to claim 5, wherein the wheels of the first wheel assembly define idler wheels which rotate at a speed substantially equal to the speed of the moving shingles.

7. The method according to claim 3, wherein the second wheel assembly includes a plurality of wheels rotatably mounted about an axis.

8. The method according to claim 7, wherein the wheels are mounted off-center relative to the shaft, thereby defining an eccentric.

9. The method according to claim 8, further including rotating the shaft of the second wheel assembly, thereby moving the second wheel assembly between an engaged position and a disengaged position; and
wherein in the engaged position, every other one of the moving shingles is urged into the second path with the second wheel assembly.

10. A shingle manufacturing apparatus comprising:
a first assembly structured and configured to move a stream of shingles; and
a diverter assembly structured and configured to engage and separate every other shingle in the stream of shingles into a first stream on a first conveyor and a second stream on a second conveyor, the diverter assembly comprising a rotatable member structured and configured to engage every other of the shingles moving in the first stream of shingles and urge each of the every other shingles into a second path toward the second conveyor.

11. The shingle manufacturing apparatus according to claim 10, wherein the diverter assembly further comprises a hold-down member structured and configured to engage the shingles moving in the first stream of shingles as the shingles move along a first path on a moving belt toward the first conveyor.

12. The shingle manufacturing apparatus according to claim 11, wherein the hold-down member comprises a first wheel assembly, and
wherein the first wheel assembly includes a plurality of wheels rotatably mounted about a shaft.

13. The shingle manufacturing apparatus according to claim 12, wherein the rotatable member engages a first end of each every other shingle while the first wheel assembly engages a second, opposite, end of each every other shingle.

14. The shingle manufacturing apparatus according to claim 12, wherein the wheels of the first wheel assembly are in contact with the moving shingles and are structured to rotate at a speed substantially equal to the speed of the moving shingles.

15. The shingle manufacturing apparatus according to claim 11, wherein the rotatable member includes a plurality of wheels rotatably mounted about a shaft.

16. The shingle manufacturing apparatus according to claim 15, wherein the wheels of the rotatable member are structured to rotate at a speed substantially equal to the speed of the moving shingles.

17. The shingle manufacturing apparatus according to claim 11, further including one of a wedge and a diverter plate downstream of the diverter assembly.

18. A shingle manufacturing apparatus comprising:
a first assembly structured and configured to move a stream of shingles; and
a diverter assembly structured and configured to engage and separate every other shingle in the stream of shingles into a first stream on a first conveyor and a second stream on a second conveyor, the diverter assembly comprising:
a rotatable shaft;
a support arm mounted to the rotatable shaft;
an idler wheel rotatably mounted to the support arm, the idler wheel structured and configured to engage the shingles moving in the first stream of shingles as the shingles move along a first path on a moving belt toward the first conveyor; and
a diverter wheel rotatably mounted to the support arm, the diverter wheel structured and configured to engage every other of the shingles moving in the first stream of shingles and urge each of the every other shingles into a second path toward the second conveyor.

19. The shingle manufacturing apparatus according to claim 18, wherein the diverter wheel engages a first end of each every other shingle while the idler wheel engages a second, opposite, end of each every other shingle.

20. The shingle manufacturing apparatus according to claim 18, further including one of a wedge and a diverter plate downstream of the diverter assembly.
